(19) United States
(12) Patent Application Publication
(10) Pub. No.: US 2019/0155050 A1
(43) Pub. Date: May 23, 2019

(54) SPECTACLE FRAME ELEMENT

(71) Applicant: Essilor International, Charenton-Le-Pont (FR)

(72) Inventors: Denis ROUSSEAU, Chare nton-Le-Pont (FR); Guillaume BROUTIN, Charenton-Le-Pont (FR); Jean SAHLER, Chare nton-Le-Pont (FR); Marie LORE, Charenton-Le-Pont (FR); Paul GIL, Charenton-Le-Pont (FR)

(73) Assignee: Essilor International, Charenton-Le-Pont (FR)

(21) Appl. No.: 16/313,264

(22) PCT Filed: Jun. 27, 2017
(86) PCT No.: PCT/EP2017/065879

§ 371 Date: Dec. 26, 2018

(30) Foreign Application Priority Data
Jun. 30, 2016 (EP) 16305817.5

(51) Int. Cl. G02C 5/18; G02C 11/00; G02C 11/04; B29D 12/02; G02C 5/00

(52) U.S. Cl. CPC G02C 5/18; G02C 11/10; G02C 5/008; B29D 12/02; G02C 11/04

(57) ABSTRACT

A spectacle frame element is provided, including a reinforcement support, wherein the reinforcement support includes an electronic support part supporting at least an electronic component and a wire core part extending from the electronic support part through the spectacle frame element, the electronic support and the wire core part are embodied in the spectacle frame element.

### FIELD OF THE INVENTION

The invention relates to a spectacle frame element comprising a reinforcement support and to a method of manufacturing such spectacle frame element.

### BACKGROUND OF THE INVENTION

Electronic spectacle frames have an important and rapid growth. More and more electronic spectacle frames are being develop with a greater variety of different electronic elements.

Electronic spectacle frame may comprise many different electronic elements such as sensors, displays, active lenses, batteries, processors for local processing and communication devices, and charging devices.

With the growing interest in electronic spectacle frames, it has become important to provide a solution that allows including electronic components in a spectacle frame.

Such electronic components usually generate heat when used. The heat generated by the electronic components into a spectacle frame must be dissipated to improve reliability, comfort and prevent premature failure.

Usual techniques for heat dissipation like fans for air cooling or liquid cooling cannot be applied because of their dimensions and impact on consumption and aesthetic of the spectacle frame.

Therefore, there is a need for a solution allowing to provide a solution for heat dissipation of electronic components to be included in a spectacle frame.

An aim of the present invention is to propose such solution.

### SUMMARY OF THE INVENTION

To this end, the invention proposes a spectacle frame element comprising a reinforcement support, wherein the reinforcement support comprises an electronic support part supporting at least an electronic component and a wire core part extending from the electronic support part through the spectacle frame element, the electronic support and the wire core part are embodied in the spectacle frame element.

Advantageously, the spectacle frame element according to the invention provides a solution for dissipating heat of an electronic component and is compatible with the traditional manufacturing spectacle frame process.

The spectacle frame element further allows dissipating heat from an electronic component while preserving the rigidity of the spectacle frame element and the ability of the spectacle frame to be waterproof.

According to further embodiments which can be considered alone or in combination:
the reinforcement support is made of a heat conducting material; and/or
the reinforcement support is made of a metallic material, for example stainless steel; and/or
the spectacle frame is in cellulose acetate; and/or
the electronic component comprises a radio wave emitting component; and/or
the electronic support part of the reinforcement support comprises at least a window arranged to be transparent to light and/or radio waves; and/or
the spectacle frame element is a spectacle temple; and/or
the electronic component comprises a light emitting component, for example a LED and the material of the spectacle frame element is at least partly transparent to light; and/or
the wire core part of the reinforcement support is tubular and an electrical wire and/or an optical fiber extends from the electronic component trough the tubular wire core part of the reinforcement support; and/or
the wire core part extends along at least 50% of the length of the spectacle temple; and/or
the reinforcement support further comprises a hinge so as to allow fixing the spectacle frame element to a further spectacle frame element.

The invention also relates to a spectacle frame comprising a spectacle frame element according to the invention.

The invention further relates to a method of manufacturing a spectacle frame according to the invention, wherein the method comprises:

a spectacle frame element providing step, during which a spectacle frame element is provided,

a reinforcement support providing step, during which a reinforcement support comprising an electronic support part supporting at least an electronic component and a wire core part extending from the electronic support is provided,

an embodying step during which the electronic support and the wire core part are embodied in the spectacle frame element upon locally heating the spectacle frame element.

The spectacle frame element may be a spectacle temple and the method may further comprises:

a slot cutting step, during which a least one slot is cut in the spectacle temple,

a half hinge positioning step, during which a metal half hinge is positioned in the slot,

a heating step, during which the spectacle frame is heated using a capitron machine inducing ultrasonic vibrations in the metal half hinge and creates heat of friction.

### BRIEF DESCRIPTION OF THE DRAWINGS

Embodiments of the invention will now be described, by way of example only, and with reference to the following drawings in which:

FIG. 1 is a schematic representation of spectacle frame according to the invention,

FIG. 2 is a schematic representation of spectacle frame temple according to the invention,

FIG. 3 is a schematic representation of a reinforcement support intended to be embodied in a spectacle frame element according to the invention,

FIG. 4 is a chart flow of a manufacturing method of the invention, and

FIG. 5 illustrates the embodying step of the invention.

### DETAILED DESCRIPTION OF PREFERRED EMBODIMENTS

Elements in the figures are illustrated for simplicity and clarity and have not necessarily been drawn to scale. For example, the dimensions of some of the elements in the figure may be exaggerated relative to other elements to help improve the understanding of the embodiments of the present invention.

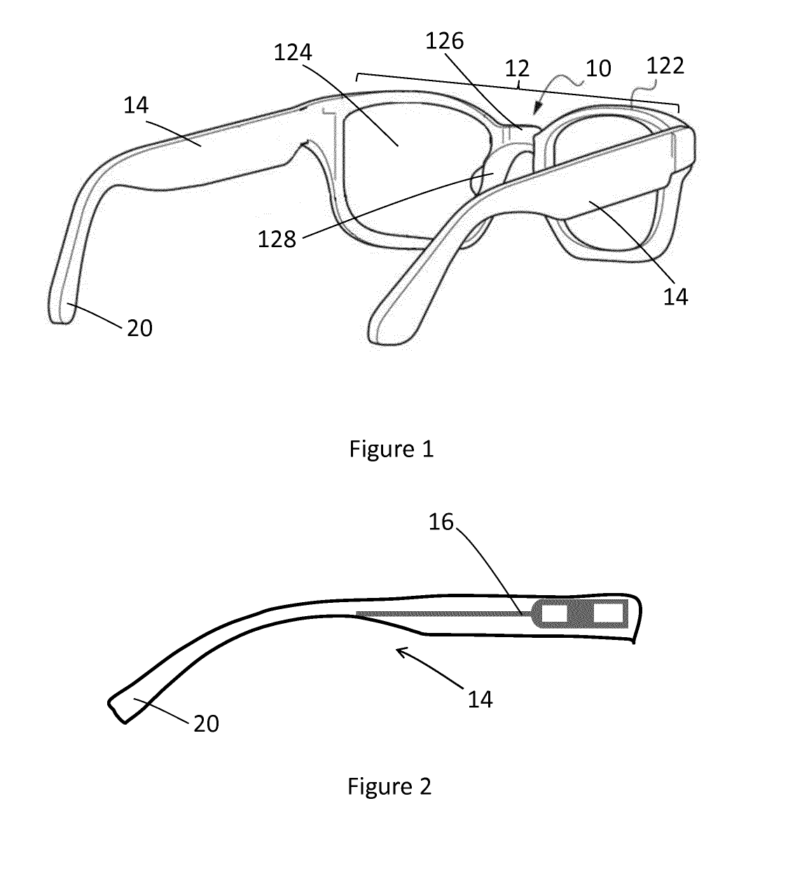

FIG. 1 represents an example of a spectacle frame 10 according to the invention. The spectacle frame 10 comprises a front part 12, a first and second temples 14.

The first and second temples 14 are configured to be attached to the front part 12, for example using hinges and screws.

As represented on FIG. 1, the front part 12 may comprise frame rims 122 arranged to receive optical lenses 124, for example ophthalmic lenses. The frame rims are linked by a bridge 126 and may comprise nose pad 128 arranged to rest on the nose of the user when the frame in worn.

The first and second temples may comprise tips 20 arranged to fit around the ears of a user when the frame is being worn by said user.

FIG. 2, is a schematic representation of an example of a spectacle frame element 14 with a reinforcement support 16 to provide rigidity to the spectacle frame element 14.

The spectacle frame element represented on FIG. 2 is a spectacle frame temple. The spectacle frame element may be made of plastic material. One of the most used plastic material for spectacle frame is cellulose acetate.

During the traditional cellulose acetate frame manufacturing process, a reinforcement support is mechanically inserted into each temples to improve the overall frame rigidity.

The spectacle frame element according to the invention maintains this traditional process step unchanged, with a reinforcement support adapted to the needs of heat dissipation of electronic components.

Preferably, the reinforcement support is made of a heat conducting material, for example a material having a thermal conductivity greater than or equal to 10 W·m⁻¹·K⁻¹, for example greater than or equal to 15 W·m⁻¹K⁻¹.

Typically, the reinforcement support may be made of a metallic material, such as stainless steel, aluminum, of thermally conductive plastics.

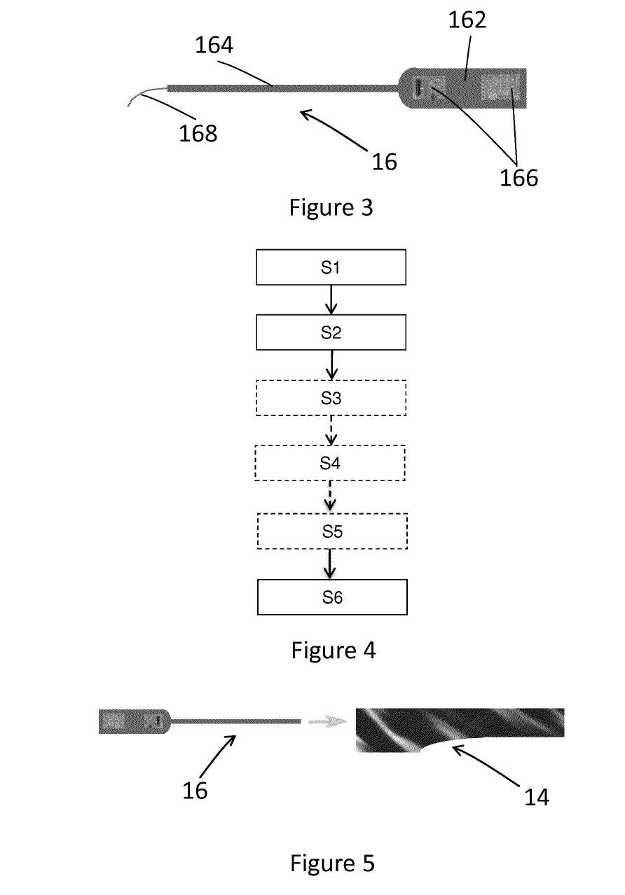

As illustrated on FIG. 3, the reinforcement support 16 used to reinforce the spectacle frame element of the invention, comprises an electronic support part 162 and a wire core part 164. The electronic support part 162 and the wire core part 164 are embodied in the spectacle frame element.

The electronic support part 162 is configured to support at least an electronic component 18.

The electronic component 18 may typically be a PCB board comprising electronic elements or a battery.

For example, the electronic component comprises a radio wave emitting component, typically adapted for Bluetooth communication.

The electronic component may comprise a light emitting component, for example a LED. According to such embodiment the material of the spectacle frame element is preferably at least partly transparent to light so as to allow the light emitted by the electronic component to be seen.

In the example represented on FIG. 3, the electronic support part 162 comprises two windows 166. The windows 166 may be arranged to be transparent to light and/or radio waves, for example such windows are through. Advantageously, such electronic support is better adapted when the electronic component is a radio wave or light emitting component.

The wire core part 164 of the reinforcement support 16 extends from the electronic support part 162 through the spectacle frame element.

The wire core part 164 of the reinforcement support 16 typically extends along at least 50% of the length of the spectacle temple, for example at least 75% so as to increase the rigidity of the spectacle temple.

As represented on FIG. 3, the wire core part of the reinforcement may be tubular and electrical wire(s) 168 and/or optical fiber(s) may extend from the electronic component trough the tubular wire core part of the reinforcement support.

Although not represented on the figures, the reinforcement support may further comprise a hinge so as to allow fixing the spectacle frame element to a further spectacle frame element.

Advantageously, the spectacle frame element according to the invention may be obtained using a traditional spectacle frame manufacturing process and allows integrating electronic component in the spectacle frame while assuring heat dissipation.

The invention further relates to a method of manufacturing a spectacle frame according to the invention.

As illustrated on FIG. 4, the method comprises at least:
a spectacle frame element providing step S1,
a reinforcement support providing step S2, and
an embodying step S6.

A spectacle frame element, for example a spectacle frame temple or front part is provided during the spectacle frame element providing step S1.

A reinforcement support is provided during the reinforcement support providing step S2. The provided reinforcement support comprises at least an electronic support part supporting at least an electronic component and a wire core part extending from the electronic support.

The reinforcement support may comprise the different arrangement previously described in greater detail.

During the embodying step S6, as illustrated on FIG. 5, the electronic support and the wire core part are embodied in the spectacle frame element upon locally heating the spectacle frame element.

When the spectacle frame element is a spectacle temple and the method for the invention may further comprise prior to the embodying step S6:
a slot cutting step S3,
a half hinge positioning step S4, and
a heating step S5.

During the slot cutting step S3, at least one slot is cut in the spectacle temple.

A metal half hinge is positioned in the slot cut in the spectacle temple during the half hinge positioning step S4.

The spectacle temple is heated using a capitron machine inducing ultrasonic vibrations in the metal half hinge and creates heat of friction during the heating step S5 so as to allow embodying the electronic support and the wire core part in the spectacle temple. The friction causes the plastic of the frame to melt locally around the hinge to bond the hinge and the reinforcement support to the frame, this process is more secure than gluing or other types of bonding or mounting.

The invention has been described above with the aid of embodiments without limitation of the general inventive concept.

Many further modifications and variations will suggest themselves to those skilled in the art upon making reference to the foregoing illustrative embodiments, which are given by way of example only and which are not intended to limit the scope of the invention, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1.-14. (canceled)

15. A spectacle frame element comprising a reinforcement support, wherein the reinforcement support comprises an electronic support part supporting at least an electronic component and a wire core part extending from the electronic support part through the spectacle frame element, the electronic support and the wire core part being embodied in the spectacle frame element.

16. The spectacle frame element according to claim 15, wherein the reinforcement support is made of a heat-conducting material.

17. The spectacle frame element according to claim 15, wherein the reinforcement support is made of a metallic material.

18. The spectacle frame element according to claim 15, wherein the reinforcement support is made of a stainless steel.

19. The spectacle frame element according to claim 15, wherein the spectacle frame is in cellulose acetate.

20. The spectacle frame element according to claim 15, wherein the electronic component comprises a radio wave emitting component.

21. The spectacle frame element according to claim 15, wherein the electronic support part of the reinforcement support comprises at least a window configured to be transparent to light waves and/or radio waves.

22. The spectacle frame element according to claim 15, wherein the spectacle frame element is a spectacle temple.

23. The spectacle frame element according to claim 15, wherein the electronic component comprises a light emitting component, and the material of the spectacle frame element is at least partly transparent to light.

24. The spectacle frame element according to claim 15, wherein the electronic component comprises a light emitting diode, and the material of the spectacle frame element is at least partly transparent to light.

25. The spectacle frame element according to claim 15, wherein the wire core part of the reinforcement support is tubular and an electrical wire and/or an optical fiber extends from the electronic component through the tubular wire core part of the reinforcement support.

26. The spectacle frame element according to claim 15, wherein the wire core part extends along at least 50% of a length of a spectacle temple.

27. The spectacle frame element according to claim 15, wherein the reinforcement support further comprises a hinge configured to allow fixing the spectacle frame element to a further spectacle frame element.

28. A spectacle frame comprising a spectacle frame element according to claim 15.

29. A method of manufacturing a spectacle frame according to claim 15, the method comprising:
providing a spectacle frame element;
providing a reinforcement support comprising an electronic support part supporting at least an electronic component and a wire core part extending from the electronic support; and
embodying the electronic support and the wire core part in the spectacle frame element upon locally heating the spectacle frame element.

30. The method according to claim 29, wherein the spectacle frame element is a spectacle temple and the method further comprises:
cutting step at least one slot in the spectacle temple;
positioning a metal half hinge in the slot; and
heating the spectacle frame using a capitron machine inducing ultrasonic vibrations in the metal half hinge and creating heat of friction.
